(19) United States
(12) Patent Application Publication
(10) Pub. No.: US 2003/0137233 A1
(43) Pub. Date: Jul. 24, 2003

(54) Monochrome cathode ray tube and manufacturing method thereof

(75) Inventors: Jong-Sang Lee, Suwon-City (KR); Hwan-Chul Rho, Busan-City (KR); IL-Hoon Kim, Seoul (KR); Chong-In Chung, Suwon-City (KR); Chul-Han Bae, Seoul (KR)

Correspondence Address: STAAS & HALSEY LLP, 700 11TH STREET, NW, SUITE 500, WASHINGTON, DC, 20001, US

(73) Assignee: SAMSUNG SDI CO., LTD., Suwon-City (KR)

(21) Appl. No.: 10/330,356

(22) Filed: Dec. 30, 2002

(30) Foreign Application Priority Data
Jan. 21, 2002 (KR) 2002-3343

(51) Int. Cl. H01J 29/18

(52) U.S. Cl. 313/474

(57) ABSTRACT

A monochrome cathode ray tube, and method of manufacture, including a face panel having a screen portion on which a single color phosphor screen is formed, and the phosphor screen being formed corresponding to an effective viewing area of an outer surface of the face panel. The cathode ray tube may further include a funnel including a neck and connected to the face panel, an electron gun mounted within the neck and emitting an electron beam, and a deflection yoke mounted on the funnel.

### CROSS-REFERENCE TO RELATED APPLICATIONS

This application claims priority to and the benefit of Korean Application No. 20023343, filed on Jan. 21, 2002 in the Korean Intellectual Property Office, the disclosure of which is incorporated herein by reference.

### BACKGROUND OF THE INVENTION

1. Field of the Invention

The present invention relates to a monochrome cathode ray tube. More particularly, the present invention relates to a monochrome cathode ray tube and a manufacturing method thereof, where the monochrome cathode ray tube can be used in a projection system.

2. Description of the Related Art

A projection system that utilizes cathode ray tubes (CRTs) to realize large screen images typically includes, as the main elements, three monochrome CRTs, each for realizing an image of a single color, e.g., a green image, a blue image, and a red image. The projection system typically further includes an optical lens system for enlarging and projecting each of the single color images to form a full color image.

In the monochrome CRT, unlike with conventional color CRTs, a phosphor screen of a single color is formed over an entire inner surface of a face panel. This phosphor screen is formed using a sedimentation method, and not the slurry method generally used for the phosphor screen in the conventional color CRT.

In the sedimentation method used for manufacturing the conventional monochrome CRT, after forming a bulb by fusing a face panel to a funnel, a phosphor suspension is injected into the bulb to produce the phosphor screen. The suspension generally includes 93 wt % of pure water, 0.06 wt % of barium acetate, 6.91 wt % of a liquid glass solution (K₂O.SiO₂) of a 28% concentration, and 0.14 wt % of a phosphor material.

The phosphor suspension injected into the bulb is precipitated onto the inner surface of the face panel for a predetermined period (approximately 10 minutes), the bulb is tilted to remove excess phosphor suspension from the bulb, then the remaining phosphor suspension is dried to thereby complete the phosphor screen. The phosphor screen produced in this manner is formed over not only an effective screen portion, corresponding to an effective viewing area of the outer surface of the face panel, but also on an inner surface of a skirt.

After the formation of the phosphor screen, a conventional lacquer layer or filming layer is formed on the phosphor screen, then aluminum evaporation is performed on this layer to form an aluminum reflective layer over inner surfaces of all of the face panel and part of the funnel. Following these sedimentation and the aluminum evaporation processes, organic materials existing in the phosphor layer are removed through a baking process.

An example of the prior art monochrome CRT that uses this sedimentation method to form the phosphor layer is Japanese Laid-Open Patent No. Heisei 7-220631, which discloses a method for forming a phosphor layer.

However, when forming the CRT phosphor screen using the sedimentation method, the phosphor material in the phosphor suspension is precipitated only by the force of gravity. This applied force of gravity, in the tamping of the phosphor material, is insufficient such that a packing density between the phosphors is reduced. As a result, cavities are formed in the resulting phosphor screen.

Further, with deterioration in the packing density, a surface of the phosphor screen tends to become rough. When such a phosphor screen is used in the monochrome CRT, a brightness of the screen is reduced. Also, heating of the phosphor screen occurs when the CRT is used for long periods. These factors reduce the overall quality of the CRT.

In addition, with the above sedimentation method, significant amounts of time are required for the process since the phosphor screen is formed by the sedimentation method of phosphor material, thereby reducing productivity.

### SUMMARY OF THE INVENTION

It is an aspect of the present invention to provide a monochrome cathode ray tube and a manufacturing method thereof. Rather than the conventional sedimentation method, a new method can be applied to increase a packing density and smoothen a surface roughness of a phosphor screen, thereby improving both the screen quality of the phosphor screen and productivity.

Additional aspects and advantages of the invention will be set forth in part in the description which follows and, in part, will be obvious from the description, or may be learned by practice of the invention.

According to the above and another aspect, an embodiment of the present invention provides a monochrome cathode ray tube, including at least: a face panel having a screen portion on which a single color phosphor screen is formed, with an effective viewing area being defined on the screen portion; a funnel including a neck and connected to the face panel; an electron gun mounted within the neck of the funnel and emitting an electron beam toward the phosphor screen; and a deflection yoke mounted at a predetermined position on an outer circumference of the funnel, with the deflection yoke acting to deflect the electron beam. The phosphor screen can be formed substantially corresponding to the effective viewing area of the screen portion of the face panel.

An inner surface of the face panel protrudes toward the electron gun to be convex in shape, and an outer surface of the face panel can be substantially flat. The face panel may include a skirt extending from edges of the screen portion and contacting the funnel, with an edge of the phosphor screen being a predetermined distance from an inner surface of the skirt. An aluminum reflective layer can be formed on the phosphor screen, the aluminum reflective layer interconnecting inner surfaces of the face panel and the funnel. Further, in an embodiment of the present invention, the phosphor screen is formed at a thickness of 20˜30 μm.

According to the above and a further aspects, an embodiment of the present invention provides for a method for manufacturing a monochrome cathode ray tube, including at least: producing a face panel that includes a screen portion and a skirt, and a funnel that includes a neck; printing a single color phosphor layer on one surface of a flexible pad, the phosphor layer being provided to a predetermined area and orientation; pressing the flexible pad onto an inner surface of the face panel such that the phosphor layer contacts the inner surface of the face panel, then removing the flexible pad such that the phosphor layer is transferred onto the inner surface of the face panel; forming a first aluminum reflective layer on inner surfaces of the screen portion and the skirt of the face panel; interconnecting the face panel and the funnel to form a bulb; and forming a second aluminum reflective layer inside the bulb.

In an embodiment of the present invention, the flexible pad may be made of silicon rubber. The printing of the phosphor layer on the flexible pad can be realized through silkscreen printing. Also, the phosphor layer may be printed on the flexible pad at a thickness of 20˜30 μm. The flexible pad may further be flat on both a surface on which the phosphor layer is formed and on an opposing surface.

In a further embodiment of the present invention, the phosphor layer may be made of a phosphor material composition including 50˜70 wt % of a phosphor material, 10˜20 wt % of a binder, and 20˜30 wt % of an organic solvent. The binder can be polyacrylate and a viscosity of the phosphor material composition may be 10,000˜20,000 cps.

### BRIEF DESCRIPTION OF THE DRAWINGS

These and other aspects and advantages of the present invention will become apparent and more readily appreciated from the following description of the embodiments, taken in conjunction with the accompanying drawings of which:

FIG. 1 illustrates a cross-sectional view of a monochrome cathode ray tube according to an embodiment of the present invention;

FIG. 2 illustrates a front view of a panel of the monochrome cathode ray tube of FIG. 1, viewed from a phosphor screen side;

FIGS. 3 through 7 and FIG. 10 illustrate schematic views describing sequential operations in a manufacture of a monochrome cathode ray tube according to an embodiment of the present invention;

FIG. 8 is an electron microscope illustration of a phosphor screen of the monochrome cathode ray tube according to an embodiment of the present invention;

FIG. 9 is a comparative example electron microscope illustration of a phosphor screen of a monochrome cathode ray tube; and

FIG. 11 is a graph showing changes in brightness retentive rates, with the passage of time, for phosphor screens of an embodiment of the present invention (example) and for the comparative example (comparative example).

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

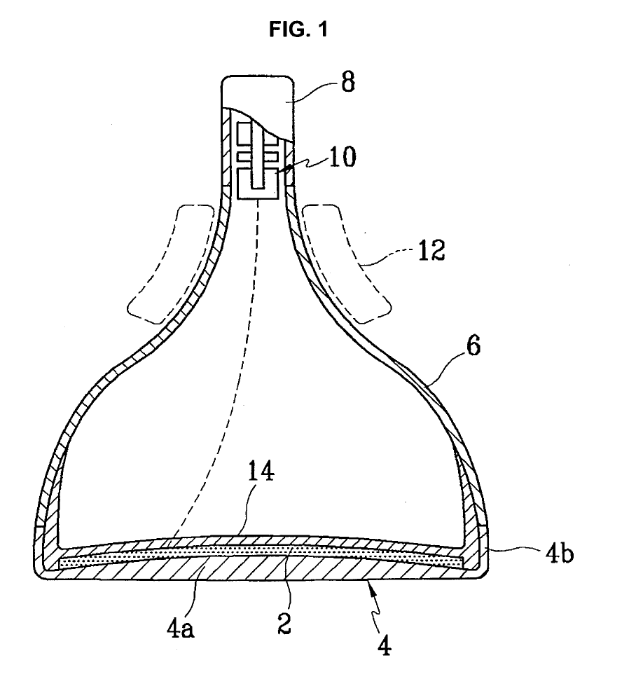

FIG. 1 illustrates a cross-sectional view of a monochrome cathode ray tube according to an embodiment of the present invention, which may be applied to a projection system.

As shown FIG. 1, the monochrome CRT includes a face panel 4, a phosphor screen 2 formed on an inner surface of the face panel 4, a funnel 6 fused to the face panel 4 to enclose the phosphor screen 2, an electron gun 10 mounted within a neck 8 of the funnel 8 and for emitting electrons that form electron beams, and a deflection yoke 12 mounted to an outer circumference of the funnel 6 to generate a magnetic field for deflection of the electron beams.

The face panel 4 includes a screen portion 4a and a skirt 4b. The skirt 4b extends from an outer circumference of the screen portion 4a in a direction toward the electron gun 10 and is fused to the funnel 6. An inner surface of the screen portion 4a is protruded, with a predetermined curve, in a direction toward the electron gun 10 such that a convex surface can be formed. This enables the screen portion 4a to perform a convex operation that may be necessary for the projection tube. An outer surface of the screen portion 4a is substantially flat. Accordingly, starting from a center of the screen portion 4a of the face panel 4 and moving toward the skirt 4b of the face panel 4, a thickness of the screen portion 4a increasingly decreases toward peripheries of the same.

The electron gun 10 is different from the electron gun used in conventional CRTs. The electron gun 10 of this embodiment of the present invention includes a single cathode. Accordingly, the electron gun 10 emits a single electron beam toward the phosphor screen 2, and this single electron beam is deflected horizontally and vertically by the magnetic field generated by the deflection yoke 12 to thereby scan the phosphor screen 2.

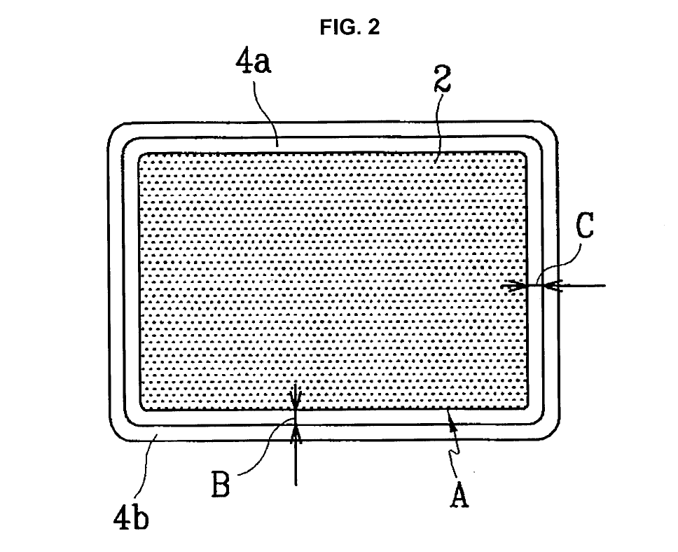

The screen panel 4a of the face panel 4, with reference to FIG. 2, includes an effective area A, which forms the actual screen. The phosphor screen 2 is formed substantially corresponding to the effective area A, on an inner surface of the face panel 4, while maintaining a predetermined distance from the inner surface of the skirt 4b of the face panel 4. That is, the phosphor screen 2 can be formed within the effective area A in such a manner that horizontal sides of the phosphor screen 2, as illustrated in FIG. 2, have a predetermined distance B from horizontal sides of the skirt 4b, and vertical sides of the phosphor screen 2, as illustrated in FIG. 2, have a predetermined distance C from vertical sides of the skirt 4b.

To increase brightness by using a metal backing effect, an aluminum reflective layer 14 can be formed on the phosphor screen 2 connecting the face panel 4 and the funnel 6. The aluminum reflective layer 14 electrically interconnects a graphite layer (not shown) formed on an inner surface of the funnel 6 and the phosphor screen 2 such that the aluminum reflective layer 14 also functions to transmit a high voltage required for acceleration of electron beams to the phosphor screen 2.

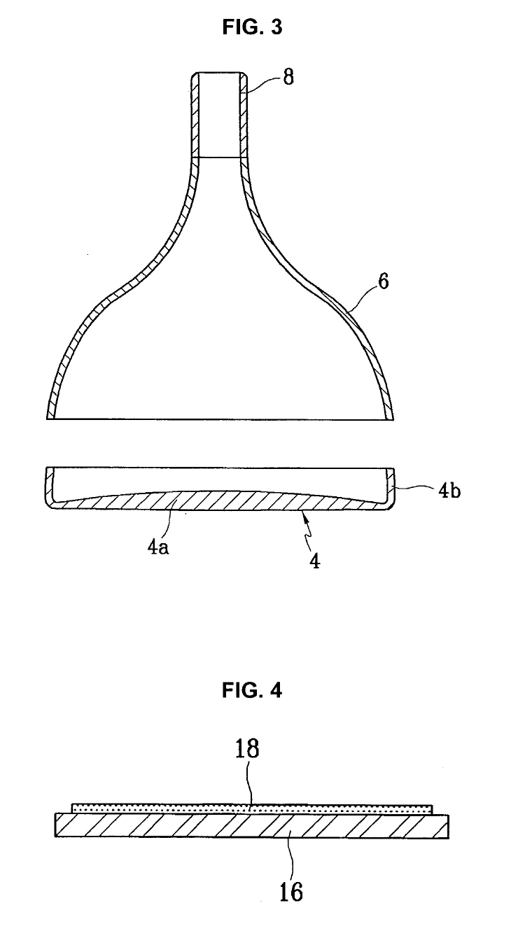

FIGS. 3 through 7 illustrate schematic views describing sequential operations in the manufacture of the monochrome cathode ray tube of an embodiment of the present invention.

First, with reference to FIG. 3, the face panel 4 that includes the screen portion 4a and the skirt 4b, and the funnel 6 that includes the neck 8 and which is fused to the face panel 4 are separately produced. Before fusing the face panel 4 and the funnel 6, using a seal frit for example, the phosphor screen 2 is formed within the screen portion 4a using a pad printing method. This will be described in more detail below.

With reference to FIG. 4, a flexible pad 16 made of pliable material, e.g., silicon rubber, is prepared. Next, using a silk screen printing device, for example, a phosphor layer 18 of a single color is printed at a thickness of 20˜30 μm on one side of the flexible pad 16. Therefore, the phosphor layer 18 may correspond to the size of the effective area A when formed on the surface of the flexible pad 16. The flexible pad 16 is preferably formed having an area larger than that of the effective area A, but is not limited thereto.

Subsequently, with reference to FIGS. 5 and 6, the flexible pad 16 is placed such that the phosphor layer 18, attached thereto, faces toward the face panel 4. The flexible pad 16 is then manipulated such that the phosphor layer 18 is contacted to the inner surface of the screen portion 4a of the face panel 4. In this state, a predetermined pressure apparatus can be used to apply a pressure to the flexible pad 16, in the direction toward the face panel 4, of approximately 5 kgf/cm², for example.

Next, the flexible pad 16 is removed from the face panel 4, such that phosphor layer 18 is left remaining on the inner surface of the screen portion 4a of the face panel 4. The phosphor layer can then be dried to thereby complete the formation of the phosphor screen 2 on the screen portion 4a of the face panel 4, as illustrated in FIG. 7.

In an example sequential operation sequence, it was found that an amount of time used in implementing these operations is roughly 2 minutes. Whereas, a sequential operation sequence required for the conventional sedimentation method required approximately 20 minutes. Thus, according to embodiments of the present invention, a significantly shorter overall operation time would be needed to form the phosphor screen 2 onto the face panel 4. As a result, the overall manufacturing time of the monochrome CRT can be reduced to thereby improve productivity.

In consideration of the formation of the inner surface of the screen portion 4a of the face panel 4, the flexible pad 16 should be flat on both sides, that is, the surface on which the phosphor layer 18 is provided and the opposite surface should be flat, though alternative padding techniques could be used. When the flexible pad 16, including the printed phosphor layer 18, is pressed against the inner surface of the screen portion 4a of the face panel 4, air bubbles may form between the phosphor layer 18 and the inner surface of the screen portion 4a. In an embodiment of the present invention, with the convex formation of the screen portion 4a and the flat formation of the flexible pad 16, a center of the phosphor layer 18 may first make contact with the screen portion 4a then portions of the phosphor layer 18 progressively toward an outer circumference of the phosphor layer 18 may make contact with the screen portion 4a, as pressure is applied to the flexible pad 16. As a result, air bubbles between the phosphor layer 18 and the screen portion 4a can be naturally forced out from between these two elements, during application of the phosphor layer 18. Hence, a problem of air bubbles may be easily solved.

In the above pad printing operation, the ability to transfer the phosphor layer 18 onto the screen portion 4a of the face panel 4 can be increased by defining its composition to accommodate for the same. In an embodiment of the present invention, the phosphor layer 18 may be made of a phosphor material composition including 50˜70 wt % of a phosphor material, 10˜20 wt % of a binder (e.g., polyacrylate), and 20˜30 wt % of an organic solvent. Also, in an embodiment of the present invention, a viscosity of the phosphor material should be 10,000˜20,000 cps.

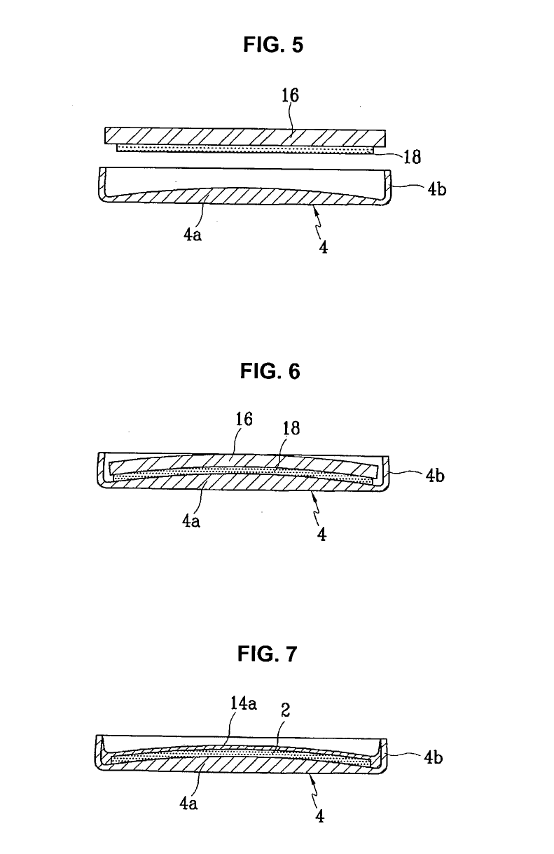

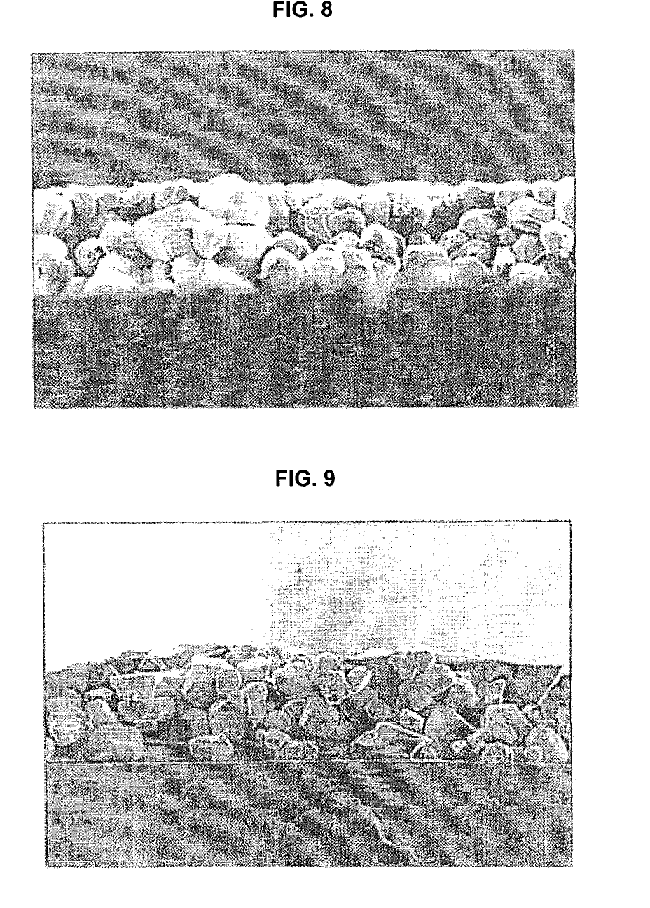

FIG. 8 is a an electron microscope illustration/photograph of a phosphor screen of the monochrome cathode ray tube according to an embodiment of the present invention, and FIG. 9 is an electron microscope illustration/photograph of a phosphor screen of a monochrome cathode ray tube of a comparative conventional example.

As shown in FIG. 8, compared to the phosphor screen formed by the conventional sedimentation method illustrated in FIG. 9, the phosphor screen according to an embodiment of the present invention is formed by phosphors that are more closely arranged, have higher tamping densities, and result in a more smoothly formed surface.

After completion of the formation of the phosphor screen 2, as described above, an aluminum reflective layer may be formed on the phosphor screen 2. However, if the face panel 4 and funnel 6 are fused directly following the formation of the aluminum layer on the phosphor screen 2, the inner surface of the face panel 4 and the inner surface of the funnel 6 may not be electrically connected. Therefore, an aluminum reflective layer may be formed before and after interconnecting the face panel 4 and the funnel 6 such that inner surfaces of the face panel 4 and the funnel 6 are electrically connected.

To realize this, a lacquer layer or a filming layer can be formed on the phosphor screen 2. Aluminum is then evaporated on this lacquer or filming layer. Next, the face panel 4 is backed to remove the lacquer layer or the filming layer. As a result, a first aluminum reflective layer 14a is formed over the inner surface of the screen portion 4a and the inner surface of the skirt 4b, as shown in FIG. 7.

Next, with reference to FIG. 10, using a seal frit 20, for example, the skirt 4b of the face panel 4 and an end of the funnel 6 are fused to form a bulb 22. Next, a second aluminum reflective layer 14b is formed within the bulb 22 covering the first aluminum reflective layer 14a, the skirt 4b, and selective portions of inner surface of the funnel 6. As a result, the inner surface of the face panel 4 and the inner surface of the funnel 6 can be made electrically connected.

If the first and second aluminum reflective layers 14a and 14b are formed in two operations, as described above, the resulting final aluminum reflective layer 14 may be thicker than needed. Therefore, the evaporated thicknesses of the first aluminum reflective layer 14a and the second aluminum reflective layer 14b can be adjusted such that the thickness of the final aluminum reflective layer 14 is substantially identical to that of the aluminum reflective layer in a conventional monochrome CRT.

Next, the electron gun 10 (not shown in FIG. 10) can be mounted within the neck 8. The bulb 22 is then connected to an exhaust assembly (not shown) to exhaust the air from within the bulb 22, thereby forming a high vacuum state within the bulb 22. The neck 8 is then sealed to maintain this vacuum state. Subsequently, the deflection yoke 12 (not shown in FIG. 10) is mounted to the outer circumference of the funnel 6 to thereby result in the monochrome CRT, as shown in FIG. 1.

As described above, the phosphor screen 2 formed using a pad printing operation can be realized through phosphors that are more closely arranged having a higher packing density, resulting in a surface of the phosphor screen 2 being more smoothly formed, which further results in an improved screen quality. Accordingly, with the improved screen quality and reduced thickness of the phosphor screen 2, spot size of electron beams emitted onto the phosphor screen 2 may be decreased to thereby improve focusing characteristics of the screen. Also, the brightness of the screen may be improved by the improvement in the packing density of the phosphors.

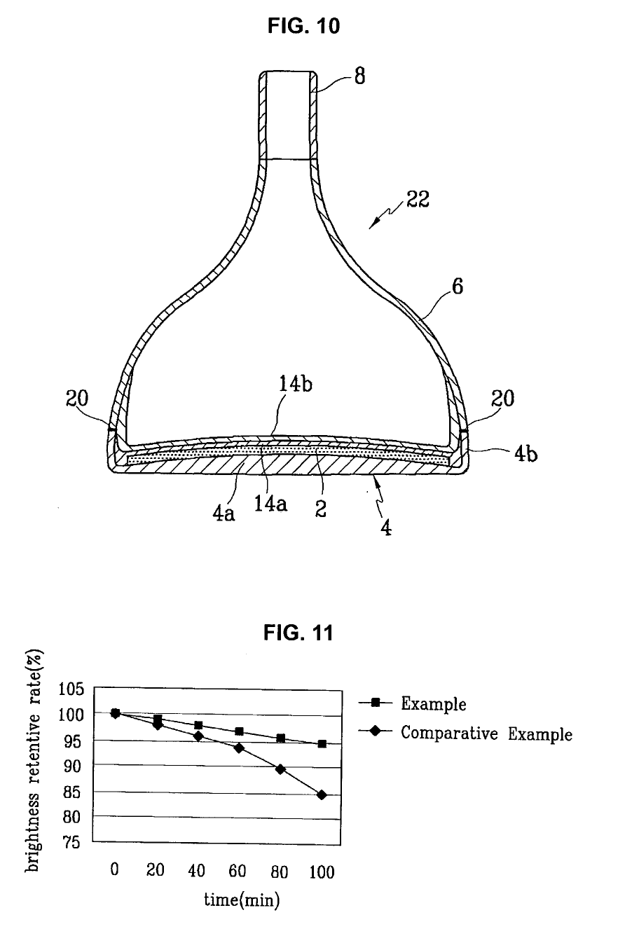

FIG. 11 is a graph showing changes in brightness retentive rates over time for a phosphor screen of an embodiment of the of the present invention (indicated as ‘Example’ in FIG. 11) and a conventional phosphor screen produced by a sedimentation method (indicated as ‘Comparative Example’ in FIG. 11). The values appearing in the graph of FIG. 11 were obtained by applying a voltage and a current respectively of 32 kV and 500 μA to the CRTs, and by emitting an electron beam in a small area of the phosphor screen (for example, 30×20 mm²).

As shown in FIG. 11, the phosphor screen according to an embodiment of the present invention exhibits a higher brightness retentive rate over time than the conventional phosphor screen, indicating that the monochrome CRT of the present invention has a phosphor screen with brightness characteristics greater than that of conventional CRTs.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A monochrome cathode ray tube, comprising:
a face panel including a screen portion having a single color phosphor screen;
a funnel including a neck and connected to the face panel;
an electron gun mounted within the neck of the funnel and emitting an electron beam toward the phosphor screen; and
a deflection yoke mounted at a predetermined position on an outer circumference of the funnel, the deflection yoke acting to deflect the electron beam, wherein the phosphor screen is formed corresponding to an effective viewing area of an outer surface of the face panel.

2. The cathode ray tube of claim 1, wherein an inner surface of the face panel protrudes toward the electron gun to be convex in shape, and the outer surface of the face panel is substantially flat.

3. The cathode ray tube of claim 1, wherein the face panel includes a skirt extending from edges of the screen portion and contacting the funnel, and an edge of the phosphor screen is oriented a predetermined distance from an inner surface of the skirt.

4. The cathode ray tube of claim 1, wherein an aluminum reflective layer is formed on the phosphor screen, the aluminum reflective layer interconnecting inner surfaces of the face panel and the funnel.

5. The cathode ray tube of claim 1, wherein the phosphor screen is formed at a thickness of 20-30 μm.

6. The cathode ray tube of claim 1, wherein the phosphor screen includes a phosphor material composition including 50-70 wt % of a phosphor material, 10-20 wt % of a binder, and 20-30 wt % of an organic solvent.

7. The cathode ray tube of claim 6, wherein the binder is polyacrylate.

8. The cathode ray tube of claim 6, wherein a viscosity of the phosphor material composition is 10,000-20,000 cps.

9. A method for manufacturing a monochrome cathode ray tube, comprising:
producing a face panel that includes a screen portion and a skirt, and a funnel that includes a neck;
printing a single color phosphor layer on one surface of a flexible pad, the phosphor layer being provided to a predetermined sized area of the flexible pad;
pressing the flexible pad onto an inner surface of the face panel such that the phosphor layer contacts the inner surface of the face panel, then removing the flexible pad such that the phosphor layer is transferred onto the inner surface of the face panel, and such that the orientation of the applied predetermined sized phosphor layer corresponds to an effective viewing area from an outer surface of the face panel;
forming a first aluminum reflective layer on inner surfaces of the screen portion and the skirt of the face panel;
interconnecting the face panel and the funnel to form a bulb; and
forming a second aluminum reflective layer inside the bulb.

10. The method of claim 9, wherein the flexible pad is made of silicon rubber.

11. The method of claim 9, further comprising silk screen printing the phosphor layer on the flexible pad.

12. The method of claim 9, further comprising printing the phosphor layer on the flexible pad at a thickness of 20-30 μm.

13. The method of claim 9, wherein the flexible pad is flat on both a surface on which the phosphor layer is formed and on an opposing surface.

14. The method of claim 9, wherein the phosphor layer is made of a phosphor material composition including 50-70 wt % of a phosphor material, 10-20 wt % of a binder, and 20-30 wt % of an organic solvent.

15. The method of claim 14, wherein the binder is polyacrylate.

16. The method of claim 14, wherein a viscosity of the phosphor material composition is 10,000-20,000 cps.

17. A monochrome cathode ray tube, comprising:
a face panel including a screen portion having a single color phosphor screen;
a funnel including a neck and connected to the face panel;
an electron gun mounted within the neck of the funnel and emitting an electron beam toward the phosphor screen; and
a deflection yoke mounted at a predetermined position on an outer circumference of the funnel, the deflection yoke acting to deflect the electron beam,
wherein the phosphor screen is formed corresponding to an effective viewing area of an outer surface of the face panel, and is formed at a thickness of 20-30 μm.

18. A monochrome cathode ray tube, comprising:
a face panel including a screen portion having a single color phosphor screen, with an orientation of the phosphor screen corresponding to an effective viewing area of an outer surface of the face panel; and
a gun mounted to emit a beam toward the phosphor screen.
